(19) United States
(12) Patent Application Publication
(10) Pub. No.: US 2011/0131060 A1
(43) Pub. Date: Jun. 2, 2011

(54) Automated System, Method and Apparatus for Providing Patient Information and Reminders Related to a Patient's Recovery Plan

(76) Inventors: David P. SCHUSTER, Redmond, WA (US); John J. SCHUSTER, Redmond, WA (US); Steven F. STUART, Santa Monica, CA (US); Scott CRUTCHER, Venice, CA (US); Fernando GARCIA, Bothell, WA (US); Daniel G. ZARZAR, Kirkland, WA (US); Gerardo DIAZ, Kirkland, WA (US); Maureen MAYER, Delray Beach, FL (US); Christopher VALERIAN, Glen Ridge, NJ (US)

(21) Appl. No.: 12/956,355

(22) Filed: Nov. 30, 2010

Related U.S. Application Data
(60) Provisional application No. 61/265,052, filed on Nov. 30, 2009.

(51) Int. Cl. G06Q 50/00; G06Q 10/00

(52) U.S. Cl. 705/3

(57) ABSTRACT

The method and system is provided where patients and their designated family and friend supporters are provided with daily, interactive, recovery support for up to 90 days following their hospital discharge. By using internet, mobile, and traditional fixed-line communications, the present invention in conjunction with supporting staff will automatically follow-up with patients on a daily basis in order to identify potential problems as they emerge while simultaneously providing a personalized recovery plan that includes daily recovery guides, medication reminders, and condition specific education, all designed to improve a patient's adherence to their doctor's prescribed treatment.

By identifying recovery problems in their early stages and improving patient adherence to prescribed treatment, the present invention will lower the risk of re-hospitalization, improve quality of care, and lower overall health care costs.

### CROSS-REFERENCE TO RELATED PATENT APPLICATION

This application claims the benefit under 35 U.S.C. §119(e) of U.S. Provisional Patent Application. No. 61/265,052, filed on Nov. 30, 2009 in the U.S. Patent and Trademark Office, the entire disclosure of which is hereby incorporated by reference.

### FIELD OF THE INVENTION

The present application relates to a system, method and apparatus for providing patient information and reminders related to a patient's recovery plan.

### BACKGROUND OF THE INVENTION

Traditionally, overwhelming and confusing discharge instructions and poor patient adherence to prescribed treatment plans have a significant and adverse impact on hospital readmission rates. Nationwide, approximately 19% of patients are readmitted to the hospital within 30 days of original discharge due to post-operative complications or infection. Furthermore, half of those patients had no contact with their doctor prior to being readmitted. A typical readmission costs between $12K to $45K, and overall, unplanned hospital readmissions are estimated to cost $56 B annually in the United States. In general, increasing patient follow-up and improving patient adherence with treatment plans are widely viewed by health insurance companies, the medical community, and the government as significant opportunities for improving patient recovery outcomes, reducing re-admission rates and lowering health care costs.

According to a study by the Annals of Internal Medicine, patients who have a clear understanding of their hospital aftercare instructions, including how to take their medicines and when to make follow-up appointments, are 30 percent less likely to be readmitted or visit the emergency room than patients who lack this information. Additionally, according to a study published in the Journal of the American College of Cardiology, targeted patient education and support intervention for heart failure patients resulted in a 39 percent decrease in the total number of readmissions and an average reduction of $7,515 in hospital costs for those who were readmitted.

Conventional systems do not provide for a solution to improve education and adherence to treatments plans outside the hospital setting. For example, conventional systems do not provide for adherence “in the home” and leverage the significant advancements in online and telephonic communications and social networks to facilitate daily recovery communication with the patient and their friends and family member supporters.

Embodiments and implementations of the present invention address at least the drawbacks associated with conventional medical discharge/patient recovery methods, systems and apparatus.

### SUMMARY OF THE INVENTION

As noted above, exemplary embodiments and/or implementations of the present invention address at least the above problems and/or disadvantages, and provide at least the advantages described below.

The exemplary embodiments and/or implementations of the present invention provide for a method, system and/or apparatus that is uniquely positioned to improve education and adherence outside the hospital setting in order to provide a solution to address this opportunity and specifically designed to improve patient awareness, engagement, and adherence to comprehensive post-operative recovery plans. In addition, the exemplary reminder services of the present invention provide for supporting and monitoring the results of new hospital and physician “Pay-For-Performance” measures used by many Managed Organizations (MCOs) and may be required to by United States Government Health Care Reform Plan.

An exemplary embodiment of the present invention provides for a system and/or method that adheres to instructions provided by a patient's doctor, and takes into account evidence-based best practices to provide patients with a personalized recovery plan. The recovery plan then helps prepare the patient for surgery, describes a typical hospital stay, and starts the planning for their subsequent discharge. Once discharged, recovery plan information, in strict compliance with the Health Insurance Portability and Accountability Act (HIPAA), is sent to patients and their designated friends and/or family member supporters. Notifying those closest to the patient allows the patient's whole social network to help support the recovery process.

According to exemplary embodiments of the present invention, each patient's recovery plan is designed to give “daily nudges” of education, encouragement and guidance during the initial 30-90 days of the recovery process. Typically, a patient and their primary family supporter will receive a morning text, email, mobile application alert, or telephone message that summarizes major events for the day such as follow-up appointments or medication changes and directs them to a custom website where more detailed information is provided.

According to exemplary embodiments of the present invention, the website and mobile application are portals for asking the patient and their family members questions that can be used to evaluate recovery progress and patient engagement.

According to an exemplary embodiment of the present invention, throughout the day, the system, method and/or apparatus can automatically provide for sending a text, email, or telephone call to the patient and their primary family supporters and provide reminders for taking medication and attending specific appointments.

According to an exemplary embodiment of the present invention, the system, method and/or apparatus can analyze each patient's responses to verify they are progressing. For example, any deviation from an expected recovery can be forwarded for review by clinical personnel to determine if additional action is required. If appropriate, clinical personnel can contact the patient directly via email or a phone call to gather additional information, which will then be forwarded to the patient's doctor. In an emergency situation, a clinician can call the patient's doctor directly or contact emergency services.

An exemplary embodiment of the present invention provides for a system that is accessible by supervisory users, such as the patient's doctor or insurance provider. For example, each supervisory user can log-in to the exemplary system of the present invention and see a summary of their patient status information for which each is authorized. In addition, each supervisory user will be able to look at the pertinent detailed responses of their authorized patients and see how those responses have changed over time in both text and graphical formats.

According to an exemplary embodiment, the system, method and/or apparatus of the present invention can generate reports for doctors and insurance companies that can summarize patient progress and highlight potential problems. For example, it can be expected that these reports may be used for evaluating hospital and doctor “pay-for-performance” outcomes and the general value of the present invention. The appropriate recipients of these reports can be notified of their online availability with email or text message. Alternatively, these reports can be encrypted as required by HIPAA standards and electronically transmitted directly to the appropriate recipients.

### BRIEF DESCRIPTION OF THE DRAWINGS

The above and other exemplary features, aspects and advantages of the present invention will become more apparent from the following detailed description of certain exemplary embodiments thereof when taken in conjunction with the accompanying drawings in which:

FIG. 1 illustrates a flow chart depicting the steps associated with the method, system and apparatus of according to an exemplary embodiment of the present invention.

FIG. 2 is a diagram that illustrates architecture associated with a method, system and apparatus of the present invention, according to an exemplary embodiment.

FIG. 3 is a schematic block diagram that illustrates architecture associated with a method, system and apparatus of the present invention, according to an exemplary embodiment.

Throughout the drawings, like reference numerals will be understood to refer to like elements, features and structures.

### DETAILED DESCRIPTION OF EXEMPLARY EMBODIMENTS

The matters exemplified in this description are provided to assist in a comprehensive understanding of exemplary embodiments of the present invention described with reference to the accompanying drawing figures. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness Likewise, certain naming conventions, labels and terms as used in the context of the present disclosure are, as would be understood by skilled artisans, non-limiting and provided only for illustrative purposes to facilitate understanding of certain exemplary implementations of the embodiments of the present invention.

According to an exemplary embodiment of the present invention, each patient's recovery plan can provide for “daily nudges” of education, encouragement and guidance during the initial 30-90 days of the recovery process. For example, a patient and their primary family supporter will receive a morning text, email, mobile application alert, or telephone message that summarizes major events for the day such as follow-up appointments or medication changes and directs them to a custom website where more detailed information is provided. For example, according to exemplary implementations of the present invention, the website can list various features including any of the following: the dosing time and a picture of each medication to be taken that day, condition specific suggestions in regards to diet, exercise, sleep positions, etc., a list of expected side effects experienced by patients at this recovery stage, and/or a list of complications that patients should discuss with their doctor immediately.

According to exemplary embodiments of the present invention, the website and mobile application are portals for asking the patient and their family members questions that can be used to evaluate recovery progress and patient engagement. For example, exemplary implementations of the present invention can present questions including but not limited to the following for assessing recovery progress: how much do you weigh today, how far did you walk yesterday, how many pills do you have left in your prescription, which of the following three pictures most closely resembles your incision, is your incision warm or hot to the touch, and/or what are your vitals today: temperature, blood pressure, pulse rate, etc.

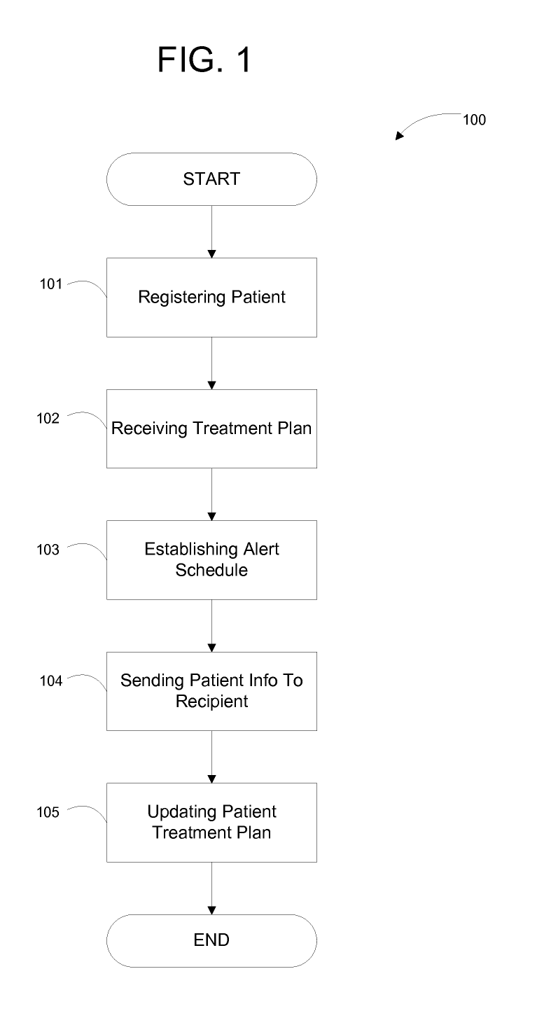

FIG. 1 illustrates a flow chart depicting the steps associated with the method, system and apparatus of according to an exemplary embodiment of the present invention.

For example, FIG. 1 illustrates an exemplary implementation of the present invention that provides an automated method 100 using a computer programmed to send reminders to a registered patient at determined intervals or event for providing a personalized recovery plan for a patient, the method comprising registering the patient that received medical service 101, receiving a patient treatment plan 102, establishing an alert schedule for sending patient information for future medical services 103, sending the patient information to at least one of patient designated recipients 104, updating patient treatment plan and/or patient information, if the designated recipient provides information 105, wherein registering and updating patient treatment plan comprises receiving said patient information from at least one of a patient medical service provider, a patient supporter, and a patient, and wherein the alert schedule is established based on the patient treatment plan.

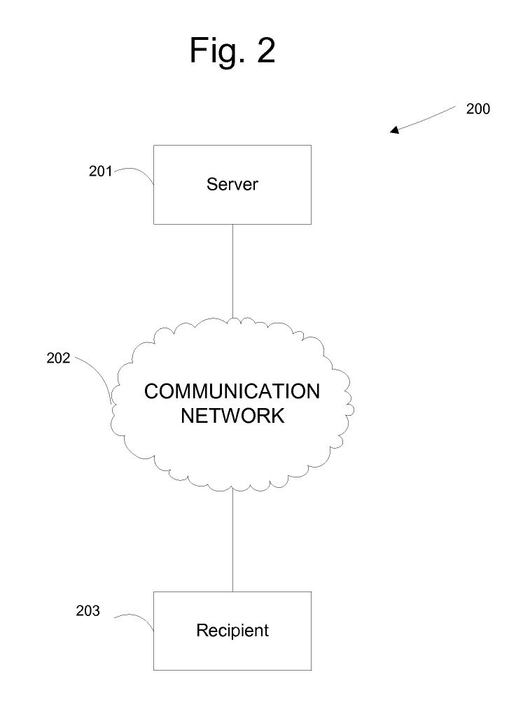

FIG. 2 is a diagram that illustrates architecture associated with a method, system and apparatus of the present invention, according to an exemplary embodiment.

For example, FIG. 2 illustrates an exemplary implementation of the present invention that provides a system 200 for providing a personalized recovery plan for a patient, the system comprising a computer server 201 programmed to provide patient related information to at least one recipient, and a recipient computer terminal 203 programmed to provide patient related information from the server, wherein the computer server comprises a first controller that provides computer executable instructions to receive patient treatment information, establish a schedule for providing patient's information related to the patient treatment information, transmit, to at least one recipient, the patient information, and update the patient related information, wherein the recipient computer terminal comprises a second controller providing computer executable instructions to receive, from the server, patient information, and transmit information to the server for updating the patient information, and wherein the server provides patient information to a recipient via an electronic communication network 202.

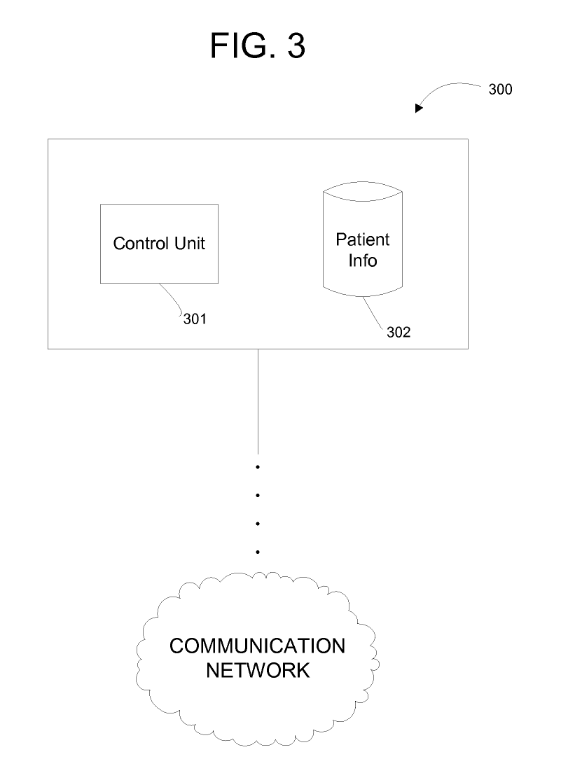

FIG. 3 is a schematic block diagram that illustrates architecture associated with a method, system and apparatus of the present invention, according to an exemplary embodiment.

For example, FIG. 3 illustrates an exemplary embodiment of the present invention that provides an apparatus 300 for providing a personalized recovery plan for a patient, the apparatus comprising a control unit 301 that provides patient information to at least one recipient, and a storage unit 302 that stores the patient information, wherein the control unit comprises executed programming instructions to receive patient treatment information, establish a schedule for providing patient's information related to the patient treatment information, transmit, to at least one recipient, the patient information, and update the patient information.

1. Condition Specific Medical Information

Exemplary embodiments and/or implementations of the present invention provide for Condition Specific Medical Information (hereinafter “CSMI”). For example, CSMI can be required for each surgical recovery condition that is monitored and supported by exemplary embodiments of the present application. CSMI can be assembled by a medical development team based upon evidence of best practices and a survey of doctor's specializing in the surgery. The development team can then use the CSMI to prepare the surgical condition's recovery plan. For example, CSMI, according to an exemplary implementation of the present invention, can include at least the following information related to a patient.

1.1. Medication

According to an exemplary implementation of the present invention, CSMI comprises patient information including but not limited to one or more of the following: A Complete List Of Medication That Is Likely To Be Taken By At Least The 95^{th} Percentile Of Patients That Undergo This Surgery; Medications Taken For Common Comorbid Conditions; and Information For Each Medication (for example, Name Of Drug—Generic And Brand Name, What It Is Used To Treat, Standard Dosage Guidelines, Time(S) Of Day When Taken, Dietary Restrictions Or Recommendations—Whether to Take With Food, Pictures Of Each Pill—Including Generics, Typical Side Effects—Minor, Dangerous Potential Complications, Any Required Monitoring Processes, Drugs That Should Not Be Mixed With Each Medication, Lifestyle Effects Or Activities That Should Be Avoided).

1.2. Wound/Incision Care

According to an exemplary implementation of the present invention, CSMI comprises patient information including but not limited to one or more of the following: Written Descriptions Of Expected Daily Incision Appearance Over Recovery Period (Color, Temperature (Heat), Discharge, Sutures, Smell, Acceptable, Minor Concerns, Serious Problems); If Available, Pictures Of Actual Incisions Representative Of The Surgery On A Day-By-Day Basis (Should Include Both Healthy Incision Healing And Incisions With Infections); and Instructions For Incision Care (Dressing Changes, Cleaning, Any Incision Medications/Ointments, and Lifestyle Instructions—Lifting/Bending Limits, Bathing Limits).

1.3. Typical Side Effects and Patient Feelings After the Surgery

According to an exemplary implementation of the present invention, CSMI comprises patient information including but not limited to one or more of the following: Name Of Side Effect With Short Description (Lack Of Appetite, Depression, and Pain Levels); Recommended Treatments (If Any); and Discussion Of When Considered Normal/Acceptable And When To Go To The Doctor.

1.4. Potential Complications Frequently Experienced By People Who Undergo the Surgery

According to an exemplary implementation of the present invention, CSMI comprises patient information, including but not limited to one or more of the following: Recovery Events Or Patient Feelings/Complaints That Indicate A Potential Problem Requiring Medical Treatment; Name Of Complication With A Short Description (Incision Infection, Fluid Retention); Discussion Of When A Complication Should Be Monitored, When To Schedule A Doctor's Appointment, Or When To Go To The Emergency Room; Text Describing How To Identify A Complication From A Patient's Perspective And From A Friend/Family Member's Perspective; In An Emergency Situation, What To Do For A Complication While Waiting For Medical Personnel.

1.5. Typical Recovery Outline For Surgical Condition

According to an exemplary implementation of the present invention, CSMI comprises patient information, including but not limited to one or more of the following: Duration Based Upon Age, Sex, Typical Comorbid Conditions, Etc. (Fast Recovery, Average Recovery, Slow Recovery); Major Events/Milestones In The Recovery Period (Suture Removal, Follow-Up Appointments); and Weekly Breakdown Of Recovery Evolution In Order To Provide Each Patient With A High Level Roadmap Of Their Expected Progress Each Week (Week 1 Focus On The Incision Healing And Proper Medication Or Other Matters Specified By Attending Physician, Week 2 Focus On Incision Healing And Limited Physical Activity Other Matters Specified By Attending Physician, Week 3 Focus On Physical Activity And Other Matters Specified By Attending Physician).

1.6. Pre-Surgery Condition Overview

According to an exemplary implementation of the present invention, CSMI comprises patient information, including but not limited to one or more of the following: Description Of The Medical Problem And How It Effects A Person's Life; Description Of What Specifically The Surgeon Will Typically Do During The Surgery; Things The Patient Should Do To Prepare For The Surgery; Things The Patient Should NOT To Do Before The Surgery; Description Of A Typically Recovery (Duration, Medication Summary, Major Things To Watch Out For, How Much Help Will The Patient Likely Need—If Possible, Break Down By Week); Description Of How The Present Invention Will Support The Recovery.

According to an exemplary implementation, pre-surgery conditions can be given to a patient, friends, family member, or any other designated recipient of the patient's information.

1.7. Post-Surgery Pain Management

According to an exemplary implementation of the present invention, CSMI comprises patient information, including but not limited to one or more of the following: Normal Types Of Pain For The Surgery (Typically, Where Is The Pain Located On The Body, How The Pain Is Typically Treated, How The Pain Is Expected To Evolve With The Recovery, Time Frame); and Abnormal/Problematic Types Of Pain For The Surgery (Where Would The Abnormal Pain Be Located On The Body, What Should The Patient Do—Follow-Up With The Doctor, Emergency Conditions).

1.8. Lifestyle Changes Typically Required on the Part of the Patient

According to an exemplary implementation of the present invention, CSMI comprises patient information including but not limited to one or more of the following: Lifestyle Changes Required During The Recovery; Lifestyle Changes Required Long Term; and Specific Areas To Address (Exercise, Sexual Activity, Nutrition)

1.9. Specific Health Parameters That Should Be Monitored During the Patient's Recovery

According to an exemplary implementation of the present invention, CSMI comprises patient information, including but not limited to one or more of the following: Name (Weight, Blood Pressure, Blood Sugar Levels); Short Description Of Parameter; Why The Parameter Is Monitored—What Problem Could Be Revealed; How Often The Parameter Should Be Checked; Normal And Out Problems Levels For Each Parameter Based Upon Age, Sex, Weight, Etc.; Suggestions On How Patient Can Monitor For Themselves; and Suggestions On How Friends/Family Members Can Monitor

1.10. Typical Follow-up/Physical Therapy Appointments for the Surgery

According to an exemplary implementation of the present invention, CSMI comprises patient information including but not limited to one or more of the following: Number Of Appointments; When Scheduled For Relative To Surgery Or Hospital Discharge; and Typical Treatment Changes That Occur During The Follow-Up (Medication, Physical Therapy).

1.11. Patient Frequently Asked Questions (FAQs) with Answers

According to an exemplary implementation of the present invention, CSMI comprises patient information including but not limited to one or more of the following: A List Of Questions And Answers Typically Asked By Patients Undergoing This Surgery.

1.12. Helpful Hints That A Typical Recovering Patient Might Find Useful

According to an exemplary implementation of the present invention, CSMI comprises information including but not limited to one or more of the following: Condition Name; and Short Write-Up (Sleep Positions, Clothing, Exercise Types, Other Websites, Social Groups, Suggestions For Friends/Family)

2. Hardware and Software Infrastructure

Exemplary embodiments and/or implementations of the present invention can be based upon various hardware and software infrastructure. For example, exemplary embodiments and/or implementations of the present invention can be stored and executed using several pieces of custom software that can be executed on standard, off-the-shelf computer hardware, as well as any computer executable medium, transitory and/or non-transitory. Further, users can interact with the system via an internet-based interface, direct email, electronic transmissions, and/or text communications. For example, users can interact with the exemplary system of the present invention via mobile applications, television “widgets”, and/or a customized Customer Relationship Management (CRM) platform.

2.1. CRM Platform

According to an exemplary implementation of the present invention, for monitoring with a CRM platform, and monitoring and guiding a patient's recovery can be analogous to managing a company's relationship with a customer. For example, similar to CRM platforms, monitoring a patients recovery relates to interactions that need to be tracked, follow-ups scheduled, and reports generated to enable managers to monitor progress. An exemplary embodiment of the present invention can provide for the utilizing Microsoft's Dynamics™ CRM system. However, regardless of the CRM system is used, exemplary embodiments of the present invention can be supported on any CRM system in various areas such as the following exemplary implementations: Enabling Clinical Personnel To Monitor Patient Responses, Providing A System For Scheduling Future Patient Contacts, Providing A System For Doctors, Nurses, And Case Managers To Log-In And Monitor A Patient's Responses And Recovery Progress, and/or Allowing Insurance Companies To Log-In And Monitor Their Patient's And A Doctor's Engagement.

2.2. Website

According to an exemplary embodiment of the present invention, an Internet Website executing the exemplary method and/or system of the present invention can provide a bi-directional interface between the system of the present invention, and a patient or a user of the system. The exemplary system of the present invention provides for asking questions of patients and supporters that can be answered in various multiple choice formats. In addition, the Internet Website, according to an implementation of the present invention, is where a patient can be provided with helpful recovery hints and links to detailed white papers in regards to their condition. The Internet Website can also include tools for monitoring progress in the form of charts and tables that will track the patient's responses over time and compare them to the responses of other patients at similar stages of recovery.

Further, according to an exemplary embodiment, the Website can also provide an interface that provides for doctors and insurance companies to monitor their patients' recoveries. For example, via the Website, these and other users can look at summary tables of all of their patients currently guided by the exemplary system of present invention as well as access detailed reports on each patient. The reports can also be available for download.

An exemplary embodiment of the present invention provides for a Website that can extract data from a CRM system and upload patient responses back into one or more databases associated with the CRM.

An exemplary embodiment of the present invention provides for a Website that is HIPAA compliant, secured, and provides access to information for patients, patient supporters, doctors, insurance companies, and other users of the exemplary system of the present invention.

2.3. Mobile Applications and Other Platforms

Exemplary embodiments of the present invention provide for mobile applications and other platforms in order to increase the convenience of using the exemplary system of the present invention. For example, custom mobile applications will be developed for a wide variety of mobile platforms including iPhone™, Windows Mobile™, Android™, and Blackberry™. In addition, the services according to exemplary implementations of the present invention can be offered as a television based application or “widget” suitable for use with systems like Apple™ TV or Google™ TV. These and other exemplary embodiments and implementations provide for mobile and television based applications can enable patient users to log into their accounts to receive medication reminders, helpful hints, respond to daily monitoring questions, etc.

2.4. Servers

Exemplary embodiments and/or implementations of the present invention and CRM platforms can run on standard servers located in HIPAA compliant facilities. According to an exemplary embodiment, having at least two redundant locations can provide for rapid disaster recovery of data as provided for by the system of the present invention.

2.5. HIPAA Compliance

Exemplary embodiments and/or implementations of the present invention provide for achieving HIPAA Compliance. For example, communication and storage of patient medical information can meet the stringent security requirements of the Health Insurance Portability and Accountability Act (HIPAA), which are incorporated herein by reference. In particular, all stored information and communications can be encrypted, and the servers hosting this information can be properly protected from improper access both physically and electronically.

3. Patient Communication

Exemplary embodiments and/or implementations of the present invention provide a system, method and apparatus for improving patient communication. For example, an exemplary embodiment of the present invention contemplates a number of communications between the exemplary system of the present invention and an individual patient via email, mobile application, text message, custom website, automated telephone call, live phone call, fax, electronic transmission and/or postal mail. Exemplary embodiments of the present invention provide for communication regarding a patient, including but not limited to one or more of the following communication (where exemplary implementations can include the listed features of the respective communication):

3.1. Consent From Patient

An exemplary implementation of the present invention provides for the following features including but not limited to one or more the following: All Aspects Of The Consent Process Are HIPAA Compliant; Send The Patient The Consent Form (Direct Mail—Include Pre-Paid Return Envelope, Email, Download From Website); Receive Consent Form From Patient (Direct Mail, Fax, Secure Online Acknowledgment With Identity Verification); Include Specific Identification Of Friends And Family Members Who Will Participate/Support Them In Their Recovery (Authorization To Contact And Contact Information—Email, Phone, Address, Etc., Two Levels Of Friend/Family Member Supporters—Primary Supporter(S) Will Receive The Same Information As The Patient, Secondary Supporters Will Only Be Contacted If The Present Invention Has A Problem Contacting The Patient Or Their Primary Supporter); If Desired By The Patient, Secondary Supporters Can Receive Weekly Status Reports That Contain Limited Information; Include Consent To Contact A Patient's Doctor(s); and Include Consent To Contact A Patient's Insurance Company

3.2. Pre-Surgery Information to Patient

3.2.1. Reminder Service's Assigned Case Manager Or Health Insurance Plan Case Manager

An exemplary implementation of the present invention provides a system that contacts the patient and explains the features of the exemplary reminder service of the present invention.

An exemplary implementation of the present invention can include features including but not limited to one or more of the following: Contacts The Patient As A Direct Phone Call In Order To Personalize The Process (Detailed Information May Be Gathered Electronically Using The Website); Verifies Patient Has Returned The Consent Form; Establishes/Verifies Preferred Method Of Contact For The Patient; Verifies Name And Contact Information For Friend And Family Member Supporters (Primary Supporters, Secondary Supporters, Asks If Patient Has Discussed The Exemplary System Of The Present Invention With Them, If Not, Asks For Permission To Contact Them In Advance In Order To Prevent Surprises, If Has Been Discussed, Asks Permission To Contact Them And Further Explain The Exemplary Method/Process Of The Present Invention); Asks About Any Other Conditions And Currently Used Medications; Tells Patient That The Reminder Services According To An Exemplary System Of The Present Invention Will Start The Day The Patient Leaves The Hospital (Contingent On Receipt Of Consent Form); Asks Them To Set-Up An Account At Nudgerx.Com, A Website According To An Exemplary System Of For The Present Invention; Explains To The Patient What To Expect Prior To And Shortly After The Surgery (Preparation For The Surgery, How They Will Feel Afterward, Some Suggestions As Far As Required Support, Direct Patient To Website For More Detailed Information); and Discuss The Value Of The Reminder Services (Faster Recovery Due To Better Adherence To Doctor's Recommendations, Guidance For Their Friend/Family Member Supporters, Daily Monitoring To Catch Recovery Issues Before They Become Problems, Timely Reminders For Medication And Follow-Up Appointments, The Ability To Compare Their Recovery With Other Similar Patients, If Applicable, Reduction In Co-Payments, If Applicable, Rebates From Their Insurance Company For Avoiding Re-Admission)

3.2.2. Follow-Up Summary Document

An exemplary implementation of the present invention can include features including but not limited to one or more of the following: E-Mail Directly Or Send A Web Link; Must Be Short Enough That The Patient Will Actually Read It; Outlines The Services Of The Present Invention And Goals; Directs Them To Set Up An Account At Nudgerx.Com, The Inventor's Website For An Exemplary System Of The Present Invention; General Information About Their Condition, Planned Surgery, And Expected Recovery; Discusses Default And Optional Information Sharing Permissions (What Family Members Can/Cannot See)—Changeable On Website; Directs Them To The Nudgerx.Com, The Inventor's Website For An Exemplary System Of The Present Invention, Or Designated General Information Website For Other Inquiries; and Contact Information For An Exemplary System Of The Present Invention's Clinical Personnel.

3.3. Pre-Surgery Test Nudge To Patient

An exemplary implementation of the present invention comprises features including but not limited to one or more of the following: A Short Message Welcoming The Patient And Wishing Them Good Luck—Asks For An Acknowledgement To Verify Address.

3.4. First Day at Home Information to Patient

An exemplary implementation of the present invention comprises features including but not limited to one or more of the following: Direct Email Or Link To 1-2 Page Summary Of Discharge Orders (Must Be Very Clear With A Step-By-Step Structure and List Of Prescription Drugs, Dosing, And Pictures); Direct Email Or Link One Page Or Less List Of Critical Warning Signs And Responses; and E-Mail A Welcome Home Message That Humanizes The Whole Process (Picture Of The Reminder Service Team, Link To Demo/Walk-Through Of Patient Portal—Provide Logon; Verify Preferred Methods Of Communication).

3.5. Daily Nudging Question/Answer—Bi-directional Between The Reminder Service And The Patient

According to an exemplary embodiment and/or implementation of the present invention, reminder and follow-up services provide the patient with guidance through the CSMI gathering. Due to the complexity of the CSMI gathering process, exemplary embodiments and/or implementations of the present method comprise features/rules of CSMI gathering including but not limited to one or more of the following: Contact Types: The Reminder Service's Website Message, Email, Text, Mobile Application Alert, Or Automated Call—Can Be Combined To Allow E-Mail Notification With Response Through Website Or Other Format Specified By Physician, Hospital, Surgeon Or Patient.; Maximum Of 3 Reminders A Day, 5 Questions Each—Response Types (Single Character Or Number Answers, Answer Menu/Check Boxes); Automated Voice Response—Additional Questions Acceptable For Response Clarification or Follow-Up; Additional Nudges Acceptable If A Potential Problem Is Identified; Questions Can Include Links To More Detailed Web Based Information—Must Assume Patients Will Rarely Look At Additional Information; Includes Prescription Refill Reminders; and Includes Future Appointment Reminders.

3.5.1. Reminder Messages

An exemplary implementation of the present invention comprises features including but not limited to one more of the following: Direct Email, Text, Electronic Transmission, And Telephone Messages Reminding The Patient About An Activity (Time Critical Messages To Take A Specific Medication, Schedule Follow-Up Appointments With Their Doctor, Reminder To Attend Follow-Up Appointment, 24 Hours In Advance, 1 Hour In Advance—Schedule Physical Therapy Appointment, Reminder To Attend Physical Therapy Appointment-24 Hours In Advance, 1 Hour In Advance, Order Or Refill A Prescription).

3.6. General Information E-mails

An exemplary implementation of the present invention comprises features including but not limited to one more of the following: 1-2 Page Documents Summarizing Expected Progress; and Typically Sent When Recovery Reaches A New Stage—Physical Therapy—Maximum Of 1 Per Week.

3.7. Weekly Summary E-mails

An exemplary implementation of the present invention comprises features including but not limited to one more of the following: A Summary Of Patient's Responses Over The Past Week With Analysis Of How They Are Doing Versus Expectation—Graphic Format Highly Desired; Encourage Participation Online With Cohorts; and Important To Provide Patient An Incentive To Review Their Progress Via The Portal For A Complete Summary Of Progress And Next Steps.

3.8. Communications About Desired Service Level

An exemplary implementation of the present invention comprises features including but not limited to one more of the following: E-Mail Or Text Asking Patient If They Would Like To Continue With The Current Level Of Support Or Reduce It, Or Increase It; and Availability Will Depend Upon Patient's Recovery And Engagement (Highly Adherent Patients That Are Progressing Well Will Be Offered A Less Frequent/Intrusive Level Of Service, Will Not Be Offered To Patients Experiencing Problems Or Showing Poor Adherence)

3.9. Patient Initiated Contact

An exemplary implementation of the present invention comprises features including but not limited to one more of the following: E-Mail, Phone, Electronic Transmission And/Or Text Message Contact (Questions, Could Require Moral Support); Primary Response Will Be Automated System; and Direct Response From The Reminder Service Personnel Available If Deemed Necessary.

3.10. Post Physician Follow-Up Appointment Communications with Patient

An exemplary implementation of the present invention comprises features including but not limited to one more of the following: The Reminder Service Calls Patient To Ask About Changes In Treatment—Also Serves To Verify Appointment Attendance.

3.11. Final Message to Patient

An exemplary implementation of the present invention comprises features including but not limited to one more of the following: Very Happy Congratulatory Message; and Thank You.

4. Communication with Primary Supporter(S)

Exemplary embodiments and/or implementations of the present invention provide a system, method and apparatus for improving various expected types of communication between the exemplary system of the present invention and at least one of an individual patient's primary supporter, such as a friend or family member supporter. In an exemplary situation where a patient has a primary supporter, the primary supporter(s) can better support a patient's recovery when they are kept informed on a patient's progress and by sharing detailed information about a patient's condition with them. In which case, the primary supporter can use this detailed information provided by an exemplary embodiment of the present invention to better evaluate progress and watch for problems while simultaneously providing moral support and family/friend peer pressure for better patient's adherence with the planned treatment. According to such an exemplary embodiment of the present invention, the primary supporter will receive the same information that the patient receives. These communications may be via email, mobile application alert, text message, automated phone call, any electronic transmission and/or the Website, according to exemplary embodiments of the present invention.

Exemplary embodiments of the present invention provide for communication with a patient's primary supporter, including but not limited to one or more of the following communication (where exemplary implementations can include the listed features of the respective communication).

4.1. Pre-Surgery Information to Primary Family Members/Friends Supporter

An exemplary implementation of the present invention comprises features including but not limited to one more of the following: A Case Manager Contacts The Primary Supporter And Explains The Program (Contingent On Receipt Of Consent From The Patient, Verifies Preferred Contact Method For The Primary Supporter, Discusses Other Patient Conditions And Currently Used Medications, Tells The Primary Supporter That The Inventor's Reminder Service Will Start The Day The Patient Leaves The Hospital, Explains To The Primary Supporter What To Expect From The Patient Prior And Shortly After The Surgery); Asks Them To Set-Up An Account At Nudgerx.Com, According to The Inventor's Website For The Present Invention; Explains To The Primary Supporter Member What To Expect From The Patient Prior To And Shortly After The Surgery (Preparation For The Surgery, How The Patient Will Feel Afterward, Some Suggestions As Far As Preparing To Support The Patient, Direct Primary Supporter To Website For More Detailed Information); and Discuss The Value Of The Inventor's Reminder Service To The Primary Supporter (Help Understanding The Doctor's Treatment Instructions And A Place The Supporter Can Go To For Support, Faster Recovery Due To Better Adherence To Doctor's Recommendations, Daily Patient Monitoring To Catch Recovery Issues Before They Become Problems, Timely Reminders For Medication And Follow-Up Appointments, The Ability To Compare The Patient's Recovery With Other Similar Patients, If Applicable, Reduction In Co-Payments, If Applicable, Rebates From Their Insurance Company For Avoiding Re-Admission).

4.2. Follow-up Summary Document to Primary Supporter

An exemplary implementation of the present invention comprises features including but not limited to one more of the following: E-Mail Directly Or Send A Web Link; Must Be Short Enough That The Primary Supporter Will Actually Read It; Outlines The Services And Goals Of The Present Invention And Discusses The Importance Of Their Participation; Directs Them To Set Up An Account At Nudgerx.Com, The Inventor's Website For The Present Invention; Outlines Their Responsibilities—As A Primary Supporter, This Individual Is Expected To Be Closely Involved With The Patient's Recovery And Will Be Informed About All Aspects For The Treatment; General Information About Their Patient's Condition, Planned Surgery, And Expected Recovery Discusses Default And Optional Information Sharing Permissions (What Other Family Members Can/Cannot See)—Changeable On Website By Patient And Primary Supporters Only; Directs Them To The Reminder Service's General Information Website For Other Inquiries; Contact Information For The Services Support Personnel; and Website Where They Can Opt-Out Of Participation.

4.3. Pre-Surgery Test Nudge to Primary Supporter

An exemplary implementation of the present invention comprises features including but not limited to one more of the following: A Short Email Or Text Message Reminding The Friends And Family Members That The Surgery Will Occur In A Few Days And That The Exemplary System Of Present Invention Will Be Guiding And Assisting The Patient For The Next 30-90 Days—Asks For An Acknowledgement To Verify Address.

4.4. First Day at Home Information to Primary Supporters

An exemplary implementation of the present invention comprises features including but not limited to one more of the following: Direct Email Or Link To 1-2 Page Summary Of Discharge Orders (Must Be Very Clear With A Step-By-Step Structure, List Of Prescription Drugs, Dosing, And Pictures); Direct Email Or Link One Page Or Less List Of Critical Warning Signs And Responses; and E-Mail A Welcome To The Recovery Process Message That Humanizes The Whole Process (Picture Of The Reminder Service Team, Link To Demo/Walk-Through Of Primary Supporter Portal, Provide Logon—Verify Preferred Methods Of Communication).

4.5. Daily Reminder Question/Answer

An exemplary embodiment of the present invention provides a service that provides the primary supporter with guidance for gathering CSMI. Due to the complexity of the CSMI gathering process, an exemplary embodiment and/or implementations of the present invention includes one or more of the following features:

Contact Types: A Website according to an exemplary system provides for Message, Email, Text, Mobile Application Alert, Electronic Transmission And/Or Automated Call which—Can Be Combined To Allow E-Mail Notification With Response Through Website Or Other Communications Platform; Maximum Of 3 Reminders A Day, 5 Questions Each—Response Types (Single Character Or Number Answers, Answer Menu/Check Boxes); Automated Voice Response—Additional Questions Acceptable For Response Clarification or Follow-Up; Additional Reminders Acceptable If A Potential Problem Is Identified; Questions Can Include Links To More Detailed Web Based Information—Can Assume Primary Supporters Will RARELY Look At Additional Information; Includes Prescription Refill Reminders; and Includes Future Appointment Reminders

4.5.1. Reminder Messages

An exemplary implementation of the present invention comprises features including but not limited to one more of the following: Direct Email Or Text Message Reminding The Primary Supporter About An Activity, according to an exemplary embodiment of the present invention can provide (Time Critical Messages To Take A Specific Medication, Schedule Follow-Up Appointments With The Doctor, Reminder To Attend Follow-Up Appointment-24 Hours In Advance, 1 Hour In Advance); and Time Dependent Upon The Distance Between The Patient's Home And The Appointment's Location (Schedule Physical Therapy Appointment, Reminder To Attend Physical Therapy Appointment-24 Hours In Advance, 1 Hour In Advance [Time Dependent Upon The Distance Between The Patient's Home And The Appointment's Location], Order Or Refill A Prescription)

4.6. General Information E-mails to Primary Supporter

An exemplary implementation of the present invention comprises features including but not limited to one more of the following: 1-2 Page Documents Summarizing Expected Progress Of The Patient; Typically Sent When Recovery Reaches A New Stage—Physical Therapy; and Maximum Of 1 Per Week.

4.7. Post Physician Follow-up Appointment Communications With Primary Supporter

An exemplary implementation of the present invention comprises features including but not limited to one more of the following: Exemplary embodiments of the present invention provides for reminder Service Calls to a patient's Primary Supporter To Ask About Changes In Treatment—Also Serves To Verify Appointment Attendance.

4.8. Weekly Summary E-mails

An exemplary implementation of the present invention comprises features including but not limited to one more of the following: A Summary Of Patient's Responses Over The Past Week With Analysis Of How They Are Doing Versus Expectation—Graphic Format Highly Desired; Encourage Participation Online With Cohorts.

4.9. Communications About Frequency of Reminders

An exemplary implementation of the present invention comprises features including but not limited to one more of the following: E-Mail Or Text Asking Primary Supporter If They Would Like Us To Continue With The Current Level Of Support Or Reduce It, Or Increase It; Availability Will Depend Upon Patient's Recovery And Engagement (Primary Supporters With Highly Adherent Patients That Are Progressing Well Will Be Offered A Less Frequent/Intrusive Level Of Service, Will Not Be Offered To Primary Supporters With Patients Experiencing Problems Or Showing Poor Adherence); and Level Of Service For The Primary Supporter Is Independent From That Selected By The Patient.

4.10. Primary Supporter-Initiated Contact

An exemplary implementation of the present invention comprises features including but not limited to one more of the following: E-Mail, Phone, Or Text Message Contact (Questions, Could Require Moral Support); and Primary Response Will Be Automated System Direct Response From The Services Support Personnel Available If Deemed Necessary.

4.11. Final Message to Primary Supporter

An exemplary implementation of the present invention comprises features including but not limited to one more of the following: Very Happy Congratulatory Message, and Thank You.

5. Communication with Secondary Supporter(S)

Exemplary embodiments and/or implementations of the present invention provide a system, method and apparatus for improving various expected type of communication between the exemplary system of the present invention and at least one of an individual patient's secondary supporter, such as a friend or family member supporter. In an exemplary situation where a patient has a secondary supporter, the secondary supporter will be contacted if a patient does not seem to be adhering to their doctor's treatment and/or the patient and their primary supporter are not responding to the reminder service. Secondary supporters can be contacted to provide an additional level of peer pressure to help motivate patient adherence. In general, the secondary supporter will not receive any contact from the inventor's reminder service beyond the initial sign-up and final message unless a problem is detected or the patient opts to allow the secondary supporter to receive weekly status reports. These communications may be via email, text message, live phone call, automated phone call, an electronic transmission and/or the Website, according to exemplary embodiments of the present invention.

Exemplary embodiments of the present invention provide for communication with a patient's secondary supporter, including but not limited to one or more of the following communication (where exemplary implementations can include the listed features of the respective communication):

5.1. Pre-Surgery Information to Secondary Family Members/Friends Supporter

An exemplary implementation of the present invention comprises features including but not limited to one more of the following: Case Manager From Reminder Service Contacts The Primary Supporter And Explains The Program According To An Exemplary Implementation Of The Present Invention (Contingent On Receipt Of Consent From The Patient, Verifies Preferred Contact Method For The Secondary Supporter, Tells The Secondary Supporter That The Reminder Services Will Start The Day The Patient Leaves The Hospital, Explains To The Secondary Supporter What To Expect From The Patient Prior And Shortly After The Surgery); and Discuss The Value Of The Reminder Services With The Secondary Supporter (Help Understanding The Doctor's Treatment Instructions And A Place The Supporter Can Go To For Support, Faster Recovery Due To Better Adherence To Doctor's Recommendations, Daily Patient Monitoring To Catch Recovery Issues Before They Become Problems, Timely Reminders For Medication And Follow-Up Appointments, The Ability To Compare The Patient's Recovery With Other Similar Patients, If Applicable, Reduction In Co-Payments, If Applicable, Rebates From Their Insurance Company For Avoiding Re-Admission)

5.2. Follow-Up Summary Document to Secondary Supporter

An exemplary implementation of the present invention comprises features including but not limited to one more of the following: E-Mail Directly Or Send A Web Link, Must Be Short Enough That The Secondary Supporter Will Actually Read It, Outlines The Reminder Services And Goals And Discusses The Importance Of Their Participation, Outlines Their Responsibilities—As A Secondary Supporter, This Individual Is Expected To Be Loosely Involved With The Patient's Recovery And Will Only Be Contacted If There Is A Problem; General Information About Their Patient's Condition, Planned Surgery, And Expected Recovery; Directs Them To The A Website Or Other Designated General Information Website For Other Inquiries; Contact Information For The Reminder Service Personnel; and Website Where They Can Opt-Out Of Participation.

5.3. Pre-Surgery Test Reminder to Secondary Supporter

An exemplary implementation of the present invention comprises features including but not limited to one more of the following: A Short Email Or Text Message Reminding The Friends And Family Members That The Surgery Will Occur In A Few Days And That The Inventor's Reminder Service Will Be Guiding And Assisting The Patient For The Next 30-90 Days—Asks For An Acknowledgement To Verify Address.

5.4. Contact with Secondary Supporter Because the Patient is Not Adhering With Treatment Plan And/Or Engaging With Reminder Service

Further, CSMI, according to exemplary and/or implementations of the present invention, can include the following information, including but not limited to the following: An Email, Text Message, Electronic Transmission Or Telephone Call Explaining To The Secondary Supporter That Patient Is Not Adhering With A Particular Aspect Of The Treatment Plan (Details About What The Patient Is Not Doing And Why It Is Important, Ask The Secondary Supporter To Contact The Patient And/Or The Primary Supporter And “Nudge” Them); Ask For An Acknowledgment In Order To Verify That The Message Was Received; Invite The Secondary Supporter To Contact The Reminder Service If They Have Any Questions; Follow-Up In One Week To Provide Feedback On Any Change In Patient Adherence.

5.5. Weekly Summary E-mails

An exemplary implementation of the present invention comprises features including but not limited to one more of the following: Only Provided To Secondary Supporters If Specifically Requested By The Patient At Enrollment; A Summary Of Patient's Responses Over The Past Week With Analysis Of How They Are Doing Versus Expectation—Graphic Format Highly Desired.

5.6. Secondary Supporter Initiated Contact With Inventor's Reminder Service

An exemplary implementation of the present invention comprises features including but not limited to one more of the following: E-Mail, Electronic Transmission, Telephone, Or Text Message Contact (Questions, Could Require Moral Support); Primary Response Will Be Automated System; Suggest They Contact The Patient's Primary Supporter; and Direct Response From The Reminder Service Personnel Available If Deemed Necessary.

5.7. Final Message to Secondary Supporter

An exemplary implementation of the present invention comprises features including but not limited to one more of the following: Their Patient's Recovery Process Has Ended; and Thank You.

6. Communication with Doctor/Hospital

Exemplary embodiments and/or implementations of the present invention provide a system, method and apparatus for improving various expected types of communication between an exemplary system of the present invention and at least one of an individual patient's Surgeon, Primary Care Doctor, and/or Hospital. These communications may be via email, text message, live phone call, mobile application, electronic transmission, automated phone call and/or the Website, according to exemplary embodiments of the present invention. According to exemplary implementations, these communications are for the exchange of information and will occur significantly less frequently than any communications with patients and their supporters.

According to an exemplary implementation of the present invention, if the reminder service is unable to contact the doctor directly, then the service can work through an assistant, office manager, or nurse.

According to an exemplary implementation, when a patient has both a surgeon and a primary care physician, the reminder service will attempt to keep both of them informed about a patient's recovery progress. Accordingly, since the primary care physician may not be receiving any type of compensation from the patient's insurance company for this service, their participation may be limited.

Exemplary embodiments of the present invention provide for communication with a patient's Surgeon, Primary Care Doctor, and/or Hospital, including but not limited to one or more of the following communication (where exemplary implementations can include the listed features of the respective communication).

6.1. Notification To The Doctor(s) That A Patient's Recovery Will Be Supported By the Reminder Service

An exemplary implementation of the present invention comprises features including but not limited to one more of the following: The Service's Case Manager Contacts The Patient's Doctor(s) And Explains The Reminder Service According To An Exemplary Embodiment Of The Present Invention (Contingent On Receipt Of Consent From The Patient, Verifies Preferred Contact Method For The Doctor's Office, Discusses Other Patient Conditions And Currently Used Medications, Tells The Doctor That The Inventor's Reminder Services Will Start The Day The Patient Leaves The Hospital); Asks Them To Set-Up An Account At A Website (such as NudgeRx.Com), According To An Exemplary Embodiment The Present Invention; Asks Them To Notify The Hospital That The Reminder Service Will Be Supporting The Patient's Recovery And That We Will Need The A Copy Of The Patient's Discharge Orders As Soon As The Patient Is Discharged; Discuss The Value Of The Present Invention's Reminder Services To The Doctor And Hospital (Less Calls To The Doctor—The Reminder Service Will Help The Patient Understand The Doctor's Treatment Instructions And A Provide Them A Place Where The Patient Can Go For Support, Better “Pay-For-Performance” Results—Reduction In Hospital Readmission Due To Better Patient Follow-Up And Reduced Hospital Readmissions, Faster Recovery Due To Better Adherence To Doctor's Recommendations, Daily Patient Monitoring To Catch Recovery Issues Before They Become Problems—Increased Patient Satisfaction Due To Frequent Follow-Up—A Strong Sense Of “Caring”, Higher Reimbursements From Insurance Companies—Reminders To The Patient To Attend Appointments); and If A Doctor Has Already Set Up A Nudegrx.Com Account And Is A Frequent User Of The Program, We Will Only Contact Them Via Email Or Telephone To Notify Them Of The Enrollment Of Their Patient Into The Reminder Service Program

6.2. Follow-up Summary Document To Doctor(s)

An exemplary implementation of the present invention comprises features including but not limited to one more of the following: E-Mail Directly Or Send A Web Link; Must Be Short Enough That The Doctor Will Actually Read It; Outlines The Inventor's Reminder Services And Goals And Discusses The Importance Of Their Participation; Directs Them To Set Up An Account At Nudgerx.Com, The Inventor's Website For The Present Invention (Allows Them To Set-Up Defaults For Reporting About The Patient's Progress From The Inventor's Reminder Service-Frequency Of Reports); Outlines The Doctor's Responsibilities In The Reminding And Follow-Up Process (The Doctor's Primary Responsibility Is To Keep The Reminder Service Informed Of The Patient's Treatment Plan—At Hospital Discharge, Any Comorbid Conditions Or Treatment Plans, Any Changes At Follow-Up Visits Or Patient Calls—The Doctor Is Also Requested To Notify The Reminder Service If The Patient Is Re-Admitted To The Hospital Or Dies—Critical To Preventing Undesirable Communications From The Reminder Service); General Information About What Information They Can Monitor Using The Service; Directs Them To The Website (such as Nudgerx.Com) According To An Exemplary System Of The Present Invention, Or Other Designated, General Information, Website For Other Inquiries; and Contact Information For The Reminder Service Personnel; Contact Information For A Representative At The Patient's Insurance Company If The Doctor Has Any Questions About Supporting The Reminder Service Program.

6.3. Post Surgery Doctor Communications

An exemplary implementation of the present invention comprises providing a message to a doctor reminding them to provide the reminders service with a copy of a patient's discharge orders.

6.4. Copy of Discharge Order at Time of Patient Discharge

An exemplary implementation of the present invention comprises features including but not limited to one more of the following: Email, Fax, Federal Express Or Other Form Of Communication (The Reminder Service May Need To Be Able To Speak To The Hospital Discharge Specialist To Proactively Get Discharge Date And Work Out The Best Format); May Have To Be Manually Entered Into The Reminder Service; Must Be RAPIDLY Processed To Support Immediate Communications With Patient; and In Some Cases The Reminder Service May Have To Engage Patient Primary Or Secondary Supporters To Send Discharge Orders To Us.

6.5. Post Follow-Up Appointment Communications With Doctor(s)

An exemplary implementation of the present invention comprises features including but not limited to one more of the following: The Reminder Service Call To Doctor To Verify Any Changes In Treatment—Contact Will Likely Be A Nurse Or MD Designee Based On The Particular Office Practice.

6.6. Patient Status Reports to Doctor(s)

An exemplary implementation of the present invention provides for a reminder service that will send the doctor a report on a patient's progress at intervals selected by the doctor on the reminder service website, according to an exemplary system of the present invention. For example, communication includes but is not limited to the following: Direct Email Of Report Or A Link On The Reminder Service Website, According To An Exemplary Embodiment Of The Present Invention; Daily, Weekly, Monthly; Report Will Show The Patient's Responses To The Reminder Service Questions With Charts And Graphs Showing Trending Over Time; and Current Patient Information Always Available To The Doctor At The Reminder Service Website, According To An Exemplary Embodiment Of The Present Invention.

6.7. Final Message to Patient's Doctor(s)

The reminder service will send a final message to a patient's doctor, according to an exemplary embodiment of the present invention. For example, communication includes but is not limited to the following: Their Patient's Recovery Process Has Ended; and Thank You.

7. Communication with Insurance Company

Exemplary embodiments and/or implementations of the present invention provide a system, method and apparatus for improving various expected types of communication between an exemplary system of the present invention and an individual patient's insurance company. These communications may be via email, text message, live phone call, automated phone call, an electronic transmission and/or the Website, according to exemplary embodiments of the present invention. According to exemplary implementations, these communications are for the exchange of information and will occur significantly less frequently than any communications with patients and their supporters.

Exemplary embodiments of the present invention provide for communication with a patient's insurance company, including but not limited to one or more of the following communication (where exemplary implementations can include the listed features of the respective communication).

7.1. Patient Identification From Insurance Company

According to an exemplary implementation of the present invention, this is the first step in the inventor's guidance/reminder process. The reminder service, according to an exemplary system of the present invention, will have a contract with the patient's insurance company to provide discharge follow-up support for specific conditions or for all conditions supported by the reminder service. As such, an insurance company will notify the inventor's reminder service of a patient's eligibility for the reminder service support at the time a treatment is pre-approved.

An exemplary implementation of the present invention provides for one or more of the following communication, including but not limited to: Electronic transfer of information from insurance company about patient including contact information and approved surgery (Pre-Authorization Number, Patient's Name, Patient's Address, Patients Phone Number, Patient's Email Address, Patient's Condition, Name Of Scheduled Surgery, Date Of Scheduled Hospital Admission And Surgery, Hospital's Name, Hospital's Address, Hospital's Phone Number, Surgeon's Name, Surgeon's Address, Surgeon's Phone Number, Surgeon's Email Address, Primary Care Physician's Name, Primary Care Physician's Address, Primary Care Physician's Phone Number, Primary Care Physician's Email Address, Insurance Company Contact's Name, Insurance Company Contact's Address, Insurance Company Contact's Phone Number, Insurance Company Contact's Email Address, E-Mail, Fax, Etc., Eligibility File And Authorization Data, Information About Any Comorbid Conditions Or Treatment Plans—Ideally Includes Patient History)

7.2. Patient Status Reports to Insurance Company

The reminder service, according to an exemplary implementation of the present invention, will send the insurance company a report on a patient's progress at intervals selected by the insurance company in their contract or as requested.

An exemplary implementation of the present invention provides for one or more of the following communication, including but not limited to: Direct Email Of Report Or A Link On The Reminder Service's Website; Daily, Weekly, Monthly; Report Will Show The Patient's Responses To The Reminder Service's Questions With Charts And Graphs Showing Trending Over Time; Current Patient Information Always Available To The Insurance Company At The Reminder Service's Website; Overall Effectiveness Reports—Once The Reminder Service Is Effectively Helping Patients, It Is In The Inventor's Interests To Share Any Data That Validates The Value Of The Service.

7.3. Report of Poor Patient Engagement With the Reminder Service Process

According to an exemplary implementation of the present invention, a patient can be eligible for reduced co-payments or potentially a rebate for engaging in the process to improve their recovery. The reminder service, according to an exemplary implementation of the present invention, provides for evaluating a patient's engagement based upon the timeliness, thoroughness, and consistency of a patient's or their Primary Supporter's responses. As such, a patient that does not appear to be fully engaged in the process will be reported to their insurance company so that appropriate steps may be taken.

An exemplary implementation of the present invention provide for one or more of the following communication, including but not limited to: A Patient Will Not Be Reported Until The Reminder Service Has Contacted Them And/Or Their Primary Supporter At Least Three Times With The Hope Of Improving Their Engagement; On The Patient's Website We Will Also Display A Graphical Indicator Of Our Evaluation Of The Patient's Adherence And Engagement—If Applicable, Could Also Be Displayed As “Progress Towards Rebate”.

7.4. Final Message to Patient's Insurance Company Contact

An exemplary implementation of the present invention provides for one or more of the following communication, including but not limited to: Their Patient's Recovery Guidance Has Ended; and Thank You.

8. Operation and Monitoring Functionality

Exemplary embodiments and/or implementations of the present invention provides for a system, method and apparatus for supporting operations and monitoring functions for the reminder service personnel. For example, an interface to the exemplary functions can be the CRM platform, but generation of the reports can be customized according to exemplary implementations.

8.1. Entry of Recovery Plan for a Specific Surgery

According to an exemplary implementation of the present invention, for each condition recovery guided by the inventor's reminder service, a Recovery Plan can be developed based upon the CSMI. This Recovery Plan and its supporting documents can be put into the CRM and website platforms. According to an exemplary implementation, the system of the present invention can be configured so that the recovery information can be entered into the system by reminder service medical personnel without extensive software developer support.

An exemplary implementation of the present invention provide for one or more of the following communication, including but not limited to: Medication List And Dosage Schedules; Wound Descriptions And Pictures; Normal Side Effects; Dangerous Complications; Recovery Outline; Pre-Surgery Information For The Patient; Pain Management; Required Lifestyle Changes; Health Parameters To Be Monitored; Follow-Up Appointment Expectations; Patient FAQs; Helpful Patient And Supporter Documents; General “Nudging” Scheduling.

8.2. New Patient Sign-Up

When the reminder service is notified that a patient has been approved for the reminder service's guidance by their insurance company or care provider, an exemplary implementation of the present invention can automatically direct the reminder service's support personnel and the patient through the sign up process. For example, the patient information can be entered into the exemplary system of the present invention, and perform the following functions: Send Consent Form To Patient; Schedule Call From Reminder Service Case Manager; Enter Contact Information For—Patient Primary Supporter(S), Secondary Supporter(S), Patient's Doctor(S), Patient's Hospital, Patient's Insurance Contact; Surgery Schedule; Send Follow-Up Summary Message About Contact Information And The Inventor's Reminder Services Available To The Patient; Website (NudgeRx.Com) Account Sign-Up Message; Information About Any Comorbid Conditions And Treatment Plans

According to an exemplary implementation of the present invention, as the reminder service company develops relationships with surgeons, it may be possible for the surgeon's office or the patient's primary care physician to gather all of the information.

8.3. Pre-Surgery Communications

An exemplary implementation of the present invention provides for one or more of the following communication, including but not limited to: Schedule Case Manager Calls (Patient's Doctor(S), Primary Supporter(S), Secondary Supporters(S)); Send Follow-Up Summary Message About Contact Information And The Reminder Service To Primary Supporters; Send Follow-Up Summary Message About Contact Information And The Reminder Service To Secondary Supporters; Send Follow-Up Summary Message About Contact Information And The Reminder Service To The Patient's Doctor(S); Send Test Messages (Patient, Primary Supporter(S), Secondary Supporter(S)); and Message To Doctor Reminding Them To Provide The Reminder Service With A Copy Of A Patient's Discharge Orders.

8.4. Entry of Patient's Discharge Orders and Start of Follow-up

Entry of a patient's discharge orders into the exemplary system of the present invention can be used to tailor the recovery program for a patient's specific condition, treatment plan, and comorbid conditions. According to an exemplary implementation of the present invention, the exemplary system of the present invention provides for clinical personnel to receive the discharge order and then enter it into the system using a condition specific recovery plan template.

According to an exemplary implementation of the present invention, the recovery plan template will present the reminder service personnel with a series of check boxes for each of the various condition variations including medication regimes, various surgical options, patient age, patient sex, typical comorbid conditions, etc., which will be checked based upon information in the discharge order. Any non-standard information will have to be entered manually with a particular focus on medications, which must be incorporated into the automated reminder platform.

According to an exemplary embodiment, the system of the present invention will then process the recovery program template and create a complete recovery program plan for the patient. At this stage, a different clinical person will review the patient's recovery program plan and their discharge orders to make sure they are consistent. If necessary, the personnel will contact the patient's doctor for any required clarifications for questions.

The reminder service, according to exemplary implementations of the present invention, provides patient guidance in accordance with their doctor's treatment plan.

8.5. Routine Patient and Primary Supporter Communications

An exemplary implementation of the present invention provides for one or more of the following communication, including but not limited to: Morning Summary Text, Email, Telephone, Mobile Application Messages; Daily Custom Websites With Monitoring Questions; Daily Reminder Messages; General Information Messages; Weekly Summary Messages; Desired Service Level Messages; Post Appointment Follow-Up Messages; and Any Patient Or Supporter Initiated Contact.

8.6. Secondary Supporter Communications

An exemplary implementation of the present invention provides for one or more of the following communication, including but not limited to: Poor Patient Adherence Reports; Follow-Up Messages; and If Appropriate, Weekly Summary Messages.

8.7. Daily Response Monitoring and Responses

According to exemplary implementations of the present invention, all communications and responses from the patient and supporters must be analyzed for potential problems. For example, the exemplary system of the present invention can analyze each response and the response trend over time to determine if the patient's recovery is progressing normally or if signs of a problem are apparent.

Potential problem responses that are detected are then logged and held for later review by clinical personnel who will further evaluate the situation and arrange the appropriate follow-up response.

Follow-up responses include: Direct Call Or Follow Up Message To The Patient From The Patient's Case Manager Or Other Clinical Personnel; Direct Call Or Follow Up Message To A Patient's Primary Supporter From The Patient's Case Manager Or Other Clinical Personnel; Direct Call Or Follow Up Message To A Patient's Doctor(S) From The Patient's Case Manager Or Other Clinical Personnel; Tailoring Of The Patient's Next Day's Questions To Reveal Further Information Or Follow-Up On A Specific Response; Send A Message To The Patient Suggesting A Specific Helpful Hint; Poor Adherence Message To The Patient's Secondary Supporter(S); Poor Adherence Message To The Patient's Insurance Company; Direct Notification Of Emergency Services.

8.7.1. Monitoring Algorithms

According to exemplary implementations of the present invention, Algorithms are used to monitor and analyze patient and supporter responses. Ideally, the algorithms will only detect real problems and not generate large numbers of false alarms. The more effective and accurate the automatic identification of problems, the fewer expensive clinical personnel will be required for response review and follow-up.

Potential algorithms include: Patient Characteristics (Age, Weight, Sex, Etc.), Condition, And Medication Dependent Algorithms That Will Schedule And Determine The Content Of Daily Messages (Medication Timing, Diet And Exercise, Expected Healing Rates, Most Likely Complications, Daily Monitoring Questions, Patient Specific Helpful Hints); Algorithms To Plan Frequency Of Messages Based Upon Prior Responses, Patient Request, And Medical Condition; Algorithms To Evaluate The Quality Of Responses In Order Plan Future Messaging Activities; Algorithms To Evaluate The Quality Of Responses In Order To Evaluate Patient Adherence; Cohort Evaluation Algorithms To Compare Patients With Similar Conditions In Order To Monitor Progress And Potentially Promote Competition—Must Allow For Different Condition Severity, Timing, Treatment Intensity, Age, Etc.; Social Support Algorithms That Will Determine The Necessity Of Contacting Primary Or Secondary Supporters And Schedule Appropriately—Medical Condition And Prior Responses Dependent; Algorithms To Adjust The Recovery Plan For Simultaneous Conditions, Drug Regimens, And Other Treatment Factors; All discrete metrics will be tracked and analyzed for trends.

8.8. Data Analysis

An exemplary system of the present invention can also routinely analyze its database for other useful information, which may not be patient specific.

An exemplary implementation of the present invention provides for one or more of the following including but not limited to: Best Recovery Results By Doctor, Hospital, And Discharge Plan; Most Effective Medications; Effectiveness Of New Treatment Techniques And Medications; Effectiveness Of Various Case Managers; Effectiveness Of Follow-Up Care Delivered By A Patient's Doctor(S) And Hospital.

8.9. Effectiveness Monitoring

An exemplary implementations of the present invention provides for monitoring its overall effectiveness at reducing the number of hospital re-admissions as well as the cost of those that still occur. Information of this type is required for the wide scale adoption of the reminder service for reducing overall health care costs.

An exemplary implementation of the present invention provides for one or more of the following for Effectiveness monitoring questions to answer through data mining: 1. For each specific condition, how does the reminder services impact hospital re-admission rates and costs; 2. Is the impact greatest for complex conditions or comparatively simple conditions; 3. What is the correlation between patient adherence and hospital re-admissions; 4. Is daily follow-up an effective way of spotting emergent problems before they become serious; 5. Are there any correlations between patient characteristics and level of engagement; and 6. Does the length of the engagement (e.g. 90 vs. 60 days) with the patient impact the rate and/or ALOS (cost) of re-admission.

According to an exemplary implementation of the present invention, in addition to monitoring overall effectiveness, the system should also continuously evaluate what aspects of its functionality have the greatest impact on patient adherence and consequently health care cost. The results of this monitoring will be used to refine and enhance the algorithms for future patients and thereby improve the overall effectiveness of the service.

According to exemplary implementations of the present invention, potential functionality questions to answer through data mining and response monitoring are: 1. What questions do patients most frequently ask for each day of their recovery; 2. What information do patients most frequently seek on the website for each day of their recovery; 3. What is the most effective/valuable facet of the reminder services of the present invention (Timely medication reminders, Incision healing pictures, Information sharing with Primary Supporters, Do different demographic groups respond differently to the reminder services, Age, Sex, Education); 4. Do different surgical recoveries benefit differently to the inventor's reminder service and Why; 5. How important to rapid recovery is strong Primary Supporter engagement; and How valuable is the sense of “caring” that daily follow-up provides to the patient.

8.9.1. General Health Care System Performance Questions

According to an exemplary implementation of the present invention, in addition to monitoring the effectiveness of the reminder service of the present invention, the exemplary system of the present invention provides insurance companies, hospitals, and doctors the opportunity to include performance evaluation survey questions into the inventor's reminder service platform. Due to the daily interaction between the reminder service and the patient, it is an ideal platform for asking patients how well they were served by the various members of the health care community.

8.10. Cost Tracking

According to an exemplary implementation of the present invention, due to the inherent capabilities and flexibility of the CRM platform, it is well suited to helping the exemplary system of the present invention to track the cost of serving a patient. By keeping track of the number of the inventor's reminder service interactions that a patient experiences, the reminder service will the benefit of being able to getting a better handle on its cost structure, which is especially critical as it grows and looks for opportunities to improve its business.

An exemplary implementation of the present invention provides for one or more of the following including but not limited to: Contact aspects to monitor per patient, including supporters: Number Of Direct Outgoing Electronic Messages—Time Of Day Of Each; Number Of Website Log-Ons And Page Views—Time Of Day Of Each; Number Of Phone Calls From/To The Reminder Service (Ideally Also Record Duration Of Each Call, Time Of Day Of Each); Number Of Responses Requiring Clinical Personnel Review; Number Of Patient Unique Incoming And Outgoing Electronic Messages (Questions From Patient Or Supporters And Their Answers, Time Of Day Of Each); and Memory Requirements Of Any Stored Patient Information.

9. Emergency Communication

Exemplary embodiments and/or implementations of the present invention provide a system, method and apparatus for reminder service that can interact with patients on a daily basis and will help patients through emergency situations. For example, the reminder service personnel are encouraged to do whatever is possible to help a patient in need of emergency care. According to exemplary implementations, the reminder service can provide for any instance where a patient should unexpectedly require medical attention. The exemplary system of the present invention provides for emergency situation according to the following procedures.

9.1. Automatic Escalation Standard Operating Procedure (SOP)

An exemplary implementation of the present invention provides for one or more of the following including but not limited to: a) If a potential emergency problem is discovered in a patient's response to a daily message, clinical personnel will first try to call the patient directly; and b) Stage 2 escalation is to call a patient's Primary Supporter.

Further, an exemplary implementation of the present invention provides for escalations beyond Stage 2, thereby assuming that the reminder service, according to an exemplary implementation of the present invention, is in real time contact with the patient or their Primary Supporter and have verified the apparent seriousness of a condition and that a problematic automatic response was not an isolated mistake.

For example, an exemplary implementation of the present invention provides for one or more of the following including but not limited to: a) Stage 3 escalation is to call a patient's doctor directly; and b) Stage 4 escalation is for the most critical situations and allows the reminder service to call emergency services for the patient.

According to exemplary implementations of the present invention, the reminder service according to an exemplary system of the present invention provides for medical personnel to be instructed to tell patients and their supporters to do what they feel is required because they are there in person and have first hand information.

Exemplary embodiments and/or implementations of the present invention provide a system, method and apparatus for a reminder service that ceases to provide service if a patient is re-admitted to the hospital or dies. If the patient is re-discharged from the hospital, the follow-up process, according to the exemplary implementation and/or method of the present invention, will be re-started from the beginning based upon the new discharge orders, assuming that they are still within the reminder service's capabilities.

10. Re-Admission or Death

Depending upon the source of this information, the reminder service will notify the patient's doctor and insurance company of the patient's death or re-admission, according to an exemplary implementation of the present invention. According to an exemplary implementation, the Primary or Secondary supporters may/may not be notified of the patient's death.

11. Record Keeping

Exemplary embodiments and/or implementations of the present invention provide a system, method and apparatus for providing patients with timely, structured access to medical information. Exemplary embodiments and/or implementations of the present invention provide for information storage and record keeping where medical information is stored in a secured, HIPAA-compliant manner.

According to exemplary embodiments and/or implementations of the present invention, patient related information will be kept in the CRM database, which can be backed up on a regular basis such that all information can be stored indefinitely. For example, records of all incoming and outgoing patient, supporter, doctor, and insurance company communications can be kept, according to the exemplary system of the present invention. The database, according to exemplary embodiment of the present invention, can provide for identifying best practices and treatment efficacy information that could become a significant value for patients and physicians.

The reminder system according to an exemplary implementation of the present invention may have to store patient medical history information in a separate database system than the CRM system. Direct access to a patient's medical records will make it much easier to create a custom recovery and care plan for a patient.

12. Social Networking

Exemplary embodiments and/or implementations of the present invention provide a system, method and apparatus for social networking between patients and/or supporters with similar conditions. This type of social interaction can provide the benefit of helping motivate patients to better adhere with their treatment plans and thus improve recovery outcomes. This type of interaction may also serve to reduce the “stress” experienced by patient supporters.

According to exemplary embodiments of the presenting invention, by offering social networking, further benefit is provided for facilitating communication between patients with similar conditions that can provide for an exchange of experiences and helpful hints helpful to others in a communications cohort. For example, patients will be able to utilize the exemplary system of the present invention for communicating things to watch out for and helpful hints.

According to exemplary embodiments of the presenting invention, it may be possible to create a competition between patients for recovery progress, which will likely provide motivation for better adherence.

For example, according to an exemplary implementation of a social networking system of the present invention, cohorts of a network can comprise a plurality of patients with similar conditions. Communications can be anonymous, but patients will be free to introduce themselves to each other.

According to an exemplary implementation of the present invention, social networking according to an exemplary system can provide for the following functions: Anonymous Introductions Of Similar Patients, A Platform For Anonymously Exchanging Information, and/or Comparison Charts And Graphs Comparing A Patient's Progress With The Other Anonymous Members Of Their Cohort.

According to exemplary implementations, social networking functions can be either built into an exemplary system according to the present invention or a separate portion of the reminder system. If the social networking is built in a separate portion, these functions will still need to interact with the CRM platform for information sharing and monitoring, as presented according to exemplary implementations of the present invention.

In addition to the condition specific embodiment and/or implementation discussed above, exemplary embodiments and/or implementations of the present invention provide a system, method and apparatus for a reminder system that has usefulness for a variety of treatments and care follow-up, including but not limited to those described herein.

13. Additional Services

13.1. Generic Surgery Recovery

According to an exemplary implementation of the present invention, a general surgery recovery and care plan is provided for a reduced reminder set compared to a more detailed plan, such as cardiac surgery recovery. For instance, general recovery plan would not offer surgery specific incision healing guidelines, but would offer generic incision guidance. That said, the general surgery recovery version would also offer the full reminder set on medication guidance since this capability is relatively independent of condition. Another area where functionality would be different is in the availability of condition specific helpful hints and recovery suggestions. The generic surgery recovery plan would offer access to patient records, interaction history and tracking by clinical support personnel. Ultimately, it is envisioned that a generic surgery recovery plan would be able to serve many more patients than custom developed plans.

13.2. Pharmaceutical Follow-Up

According to an exemplary implementation, and similar to a generic surgery recovery plan, the exemplary reminder system of the present invention can provide for a pharmaceutical system comprising a reduced function set tailored to specifically guiding a patient's adherence with a medication regime. Such a pharmaceutical system would be particularly useful for certain medications that are expensive and must be taken exactly as prescribed or their effectiveness is greatly reduced.

Additionally, the exemplary system of the present invention can provide for documenting and enhancing compliance of treatment protocols in efficacy trials of new medications or therapies. Enhanced patient compliance provides for the collection of valid efficacy data.

According to an exemplary embodiment of the present invention, a pharmaceutical implementation can provide for core medication reminders and follow-up functionalities. For example, patients would receive time specific email or text message reminders to take medication and would be directed to the reminder service website for follow-up questions regarding side effects, effectiveness, and dosage adherence.

13.3. Behavioral Health

In general, behavioral health patients require frequent doctor and support staff interaction. Missed appointments pose a very serious problem. Some behavioral health symptoms may diminish the abilities of the afflicted patients to adhere rigorously to a medication regime adherence without external help. Indeed, many behavioral health providers spend significant amounts of clinical personnel time contacting their patients and helping them follow their treatment regimes.

Exemplary embodiments and/or implementations of the present invention can help patients and professionals with behavioral health. For example, medication and appointment reminders can be sent via text, email and pre-recorded voice messages. For example, the exemplary system of the present invention can provide for allowing a care provider to tailor the number of automatic reminders that were sent to a patient. Website responses would be used to evaluate patient engagement and adherence. Access to clinical personnel could be tailored to the condition.

13.4. Automatic Monitoring Devices

Conventionally, patients manually enter any measured health parameters such as weight, blood pressure, temperature, etc. into their profile through a reminder system website or through dedicated messages.

An exemplary embodiment of the present invention provides for a home medical instrumentation that automatically uploads information to a patient's computer via wires or wireless protocol, patient information can then automatically be transmitted for monitoring by the invention's monitoring algorithms and support staff.

The above-described exemplary embodiments of an apparatus, system and method in computer-readable media include program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An automated method using a computer programmed to send reminders to a registered patient at determined intervals or events for providing a personalized recovery plan for a patient, the method comprising:
registering the patient that received medical service;
receiving a patient treatment plan;
establishing an alert schedule for sending patient information for future medical services;
sending the patient information to at least one of patient designated recipients; and
updating patient treatment plan and/or patient information, if the designated recipient provides information,
wherein registering comprises receiving said patient information from at least one of a patient medical service provider, a patient supporter, and a patient, and
wherein the alert schedule is established based on the patient treatment plan.

2. The method of claim 1, wherein the patient's designated recipients comprises at least one of the patient, the patient's supporter, the patient's medical service provider, and any other recipient designated by the patient.

3. The method of claim 1, where the alert comprises at least one of a reminder, a notification, medication information, appointment information, medical information, and instructions related to the patient.

4. The method of claim 1, wherein sending comprises transmitting to the patient's designated recipients, at least one of the alert, scheduled information and unscheduled information.

5. The method of claim 4, wherein unscheduled information comprises educational information.

6. The method of claim 1, wherein sending the patient's information compromises transmitting information to the patient via at least one of a text message, an email, an alert, a mobile application, a computer application, a computer executable instructions, a telephone call, a telephone message, an electronic transmission, and a television.

7. The method of claim 1, wherein updating comprises updating at least one of the patient's information, the alert schedule, and the patient's treatment plan.

8. The method of claim 1, wherein the patient's treatment plan is established by the patient's medical service provider.

9. A non-transitory computer readable medium comprising computer readable instructions for executing the method claimed in claim 1.

10. A system for providing a personalized recovery plan for a patient, the system comprising:
a computer server programmed to provide patient related information to at least one recipient; and
a recipient computer terminal programmed to provide patient related information from the server,
wherein the computer server comprises a first controller that provides computer executable instructions to:
receive patient treatment information,
establish a schedule for providing patient's information related to the patient treatment information,
transmit, to at least one recipient, the patient information, and
update the patient related information,
wherein the recipient computer terminal comprises a second controller providing computer executable instructions to:
receive, from the server, patient information, and
transmit information to the server for updating the patient information, and
wherein the server provides patient information to a recipient via an electronic communication network.

11. The system of claim 10, wherein the recipient computer terminal comprises at least one of the patient, the patients supporter, the patient's medical service provider, and any other recipient designated by the patient.

12. The system of claim 10, wherein establishing a schedule comprises establishing a patient personalized recovery plan related to the patient treatment information.

13. The system of claim 10, where the network comprises at least one of an Internet network, a local area computer network, a wide area computer network, a private computer network, and a public computer network.

14. The system of claim 10, wherein the system comprises storage for storing patient related information.

15. The system of claim 10, wherein the recipient comprises a user interface for displaying a personalized recovery plan for a patient.

16. An apparatus for providing a personalized recovery plan for a patient, the apparatus comprising:
a control unit that provides patient information to at least one recipient; and
a storage unit that stores the patient information;
wherein the control unit comprises executed programming instructions to:
receive patient treatment information,
establish a schedule for providing patient's information related to the patient treatment information,
transmit, to at least one recipient, the patient information, and
update the patient information.

17. The apparatus of claim 16, wherein transmitting further comprises transmitting to a recipient, at least one of the alert, scheduled information, and unscheduled information.

18. The apparatus of claim 16, wherein the control unit provides patient's information via a computer implemented network.
